(19) United States
(12) Patent Application Publication
(10) Pub. No.: US 2010/0180057 A1
(43) Pub. Date: Jul. 15, 2010

(54) Data Structure For Implementing Priority Queues

(75) Inventors: Gonzalo Navarro, Santiago (CL); Rodrigo Andres Paredes Moraleda, Santiago (CL)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/351,364

(22) Filed: Jan. 9, 2009

(51) Int. Cl. G06F 13/37

(52) U.S. Cl. 710/115

(57) ABSTRACT

Particular embodiments of the present invention are related to implementing a priority queue.

### TECHNICAL FIELD

The present disclosure generally relates to data structures.

### BACKGROUND

As the popularity of the Internet has increased, so has the prevalence of search engines. Generally speaking, a search engine is an information retrieval system designed to assist in finding information stored on a computer system. Search engines are often used to minimize the time required to find information and the amount of information which must be consulted. A commonly-used type of search engine is a web search engine which assists in searching for information on the World Wide Web (e.g., Yahoo!, Google, etc.).

A search engine may provide an interface to a group of items that enables a user to specify criteria about an item of interest and instruct the search engine to find items relevant to the criteria. The criteria are referred to as a search query. The search engine may return a list of items that meet the criteria specified by the query which may be sorted or ranked. For example, ranking items by relevance (from highest to lowest) may reduce the time required for a user to find desired information. Probabilistic search engines rank items based on measures of similarity (between each item and the query, typically on a scale of 1 to 0, 1 being most similar) and sometimes popularity or authority or use relevance feedback.

To provide a set of matching items that are sorted according to some criteria quickly, a search engine will typically collect metadata about the group of items under consideration beforehand through a process referred to as indexing. The index typically requires a smaller amount of computer storage, which is why some search engines only store the indexed information and not the full content of each item, and instead provide a method of navigating to the items in the search engine result page. Alternatively, the search engine may store a copy of each item in a cache so that users can see the state of the item at the time it was indexed or for archive purposes or to make repetitive processes work more efficiently and quickly.

In implementations where search results are indexed and assigned a relevancy score, the various relevancy scores for a particular search query may be thought of as an array of elements. Accordingly, when a search query is performed, it may be desirable to order the relevancy scores associated with the search results in order to return the results to a user in order of relevancy. In programming, a data structure known as a “priority queue” may be used to maintain such relevancy scores. Generally speaking a priority queue is a data structure that orders items by a priority value. Often, the first item that is removed from the queue generally has the highest priority value, after which the second highest item has the second highest value, and so on.

Many traditional approaches to implementing priority queues have disadvantages. For example, some traditional implementations may require massive amounts of storage resources, and thus may be impractical in many applications. As another example, some traditional implementations may require large computational complexity in order to implement, and thus may be inefficient in many applications.

### SUMMARY

The present invention provides methods, apparatuses and systems directed to implementing a priority queue data structure. The data structure described may have less complexity and may be implemented more efficiently than traditional approaches to implementing priority queues.

### DESCRIPTION OF THE DRAWINGS

FIG. 1 is a schematic diagram that illustrates an example network environment in which particular implementations of the invention may operate.

FIG. 2 is a schematic diagram illustrating a client host environment to which implementations of the invention may have application.

FIG. 3 illustrates an embodiment of the incremental quicksort (IQS) algorithm to which implementations of the invention may have application.

FIG. 4 illustrates an example execution of the IQS algorithm depicted in FIG. 3 to which implementations of the invention may have application.

FIG. 5 illustrates sub-structures of a quickheap data structure to which implementations of the invention may have application.

FIGS. 6A-6H illustrate example pseudo-code for implementing various quickheap operations to which implementations of the invention may have application.

FIG. 7 illustrates a diagram graphically depicting the insertion of a new element into a quickheap in accordance with the algorithms depicted in FIG. 6F.

FIG. 8 is a schematic diagram illustrating an example computing system architecture that may be used to implement one or more of physical servers depicted in FIG. 1.

### DESCRIPTION OF EXAMPLE EMBODIMENT(S)

A. Overview

Particular embodiments of the present invention are related to implementing a priority queue data structure which may be referred to herein as a “quickheap.” A quickheap may be a data structure for efficiently implementing a priority queue. The quickheap may provide for maintaining an element set in a partially ordered way, thus allowing efficient insertion of new elements into the set, extractions from elements of the set according to priorities of the respective elements, and/or other operations.

The present invention can be implemented in a variety of manners, as discussed in more detail below. Other implementations of the invention may be practiced without some or all of specific details set forth below. In some instances, well known structures and/or processes have not been described in detail so that the present invention is not unnecessarily obscured.

B. Example Network Environment

Particular implementations of the invention operate in a wide area network environment, such as the Internet, including multiple network addressable systems. Network cloud 60 generally represents one or more interconnected networks, over which the systems and hosts described herein can communicate. Network cloud 60 may include packet-based wide area networks (such as the Internet), private networks, wireless networks, satellite networks, cellular networks, paging networks, and the like.

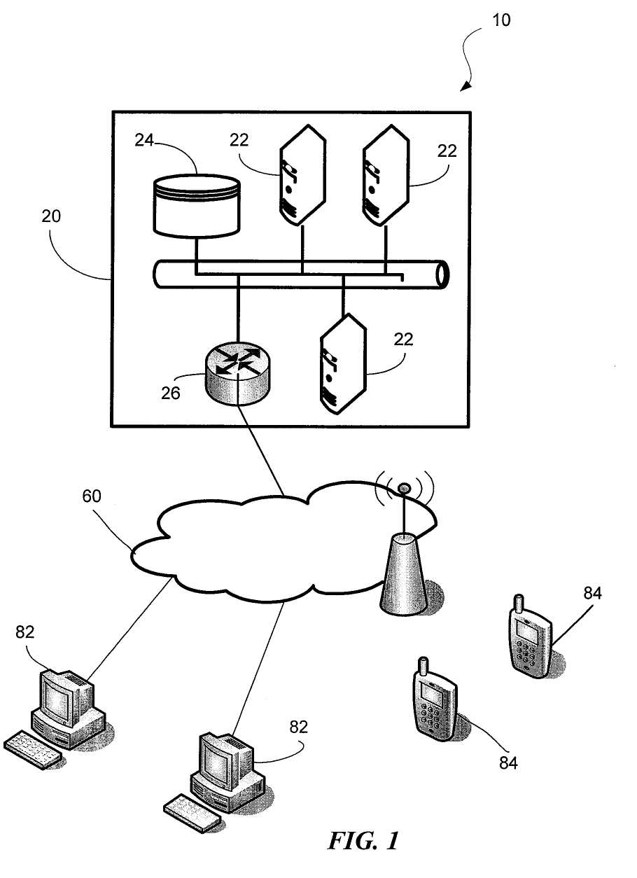

As FIG. 1 illustrates, a particular implementation of the invention can operate in a network environment comprising network application hosting site 20, such as an informational web site, social network site and the like. Although FIG. 1 illustrates only one network application hosting site, implementations of the invention may operate in network environments that include multiples of one or more of the individual systems and sites disclosed herein. Client nodes 82, 84 are operably connected to the network environment via a network service provider or any other suitable means.

Network application hosting site 20 is a network addressable system that hosts a network application accessible to one or more users over a computer network. The network application may be an informational web site where users request and receive identified web pages and other content over the computer network. The network application may also be a search platform supporting one or more search engines.

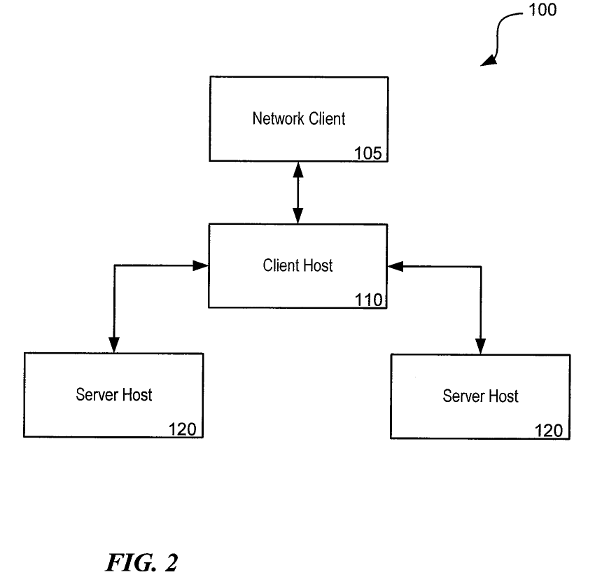

Network application hosting site 20, in one implementation, comprises one or more physical servers 22 and content data store 24. The one or more physical servers 22 are operably connected to computer network 60 via a router 26. The one or more physical servers 22 host functionality that provides a network application (e.g, a news content site, etc.) to a user. As discussed in connection with FIG. 2, in one implementation, the functionality hosted by the one or more physical servers 22 may include web or HTTP servers, ad serving systems, geo-targeting systems, and the like. Still further, some or all of the functionality described herein may be accessible using an HTTP interface or presented as a web service using SOAP or other suitable protocols.

Content data store 24 stores content as digital content data objects. A content data object or content object, in particular implementations, is an individual item of digital information typically stored or embodied in a data file or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Structurally, content data store 24 connotes a large class of data storage and management systems. In particular implementations, content data store 24 may be implemented by any suitable physical system including components, such as database servers, mass storage media, media library systems, and the like.

Network application hosting site 20, in one implementation, provides web pages, such as front pages, that include an information package or module describing one or more attributes of a network addressable resource, such as a web page containing an article or product description, a downloadable or streaming media file, and the like. The web page may also include one or more ads, such as banner ads, text-based ads, sponsored videos, games, and the like. Generally, web pages and other resources include hypertext links or other controls that a user can activate to retrieve additional web pages or resources. A user “clicks” on the hyperlink with a computer input device to initiate a retrieval request to retrieve the information associated with the hyperlink or control.

FIG. 2 illustrates the functional modules of a client host server environment 100 within network application hosting site 20 according to one particular implementation. As FIG. 2 illustrates, network application hosting site 20 may comprise one or more network clients 105 and one or more client hosts 110 operating in conjunction with one or more server hosts 120. The foregoing functional modules may be realized by hardware, executable modules stored on a computer readable medium, or a combination of both. The functional modules, for example, may be hosted on one or more physical servers 22 and/or one or more client computers 82, 84.

Network client 105 may be a web client hosted on client computers 82, 84, a client host 110 located on physical server 22, or a server host located on physical server 22. Client host 110 may be an executable web or HTTP server module that accepts HyperText Transport Protocol (HTTP) requests from network clients 105 acting as a web clients, such web browser client applications hosted on client computers 82, 84, and serving HTTP responses including contents, such as HyperText Markup Language (HTML) documents and linked objects (images, advertisements, etc.). Client host 110 may also be an executable module that accepts Simple Object Access Protocol (SOAP) requests from one or more client hosts 110 or one or more server hosts 120. In one implementation, client host 110 has the capability of delegating all or part of single or multiple requests from network client 105 to one or more server hosts 120. Client host 110, as discussed above, may operate to deliver a network application, such as an informational web page or an internet search service.

In a particular implementation, client host 110 may act as a server host 120 to another client host 110 and may function to further delegate requests to one or more server hosts 120 and/or one or more client hosts 110. Server hosts 120 host one or more server applications, such as an ad selection server, sponsored search server, content customization server, and the like.

C. Client Nodes & Example Protocol Environment

A client node is a computer or computing device including functionality for communicating over a computer network. A client node can be a desktop computer 82, laptop computer, as well as mobile devices 84, such as cellular telephones, personal digital assistants. A client node may execute one or more client applications, such as a web browser, to access and view content over a computer network. In particular implementations, the client applications allow users to enter addresses of specific network resources to be retrieved. These addresses can be Uniform Resource Locators, or URLs. In addition, once a page or other resource has been retrieved, the client applications may provide access to other pages or records when the user “clicks” on hyperlinks to other resources. In some implementations, such hyperlinks are located within web pages and provide an automated way for the user to enter the URL of another page and to retrieve that page. The pages or resources can be data records including as content plain textual information, or more complex digitally encoded multimedia content, such as software programs or other code objects, graphics, images, audio signals, videos, and so forth.

The networked systems described herein can communicate over the network 60 using any suitable communications protocols. For example, client nodes 82, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols, may be used. In addition, a server in one interaction context may be a client in another interaction context. Still further, in particular implementations, the information transmitted between hosts may be formatted as HyperText Markup Language (HTML) documents. Other structured document languages or formats can be used, such as XML, and the like.

In some client-server protocols, such as the use of HTML over HTTP, a server generally transmits a response to a request from a client. The response may comprise one or more data objects. For example, the response may comprise a first data object, followed by subsequently transmitted data objects. In one implementation, for example, a client request may cause a server to respond with a first data object, such as an HTML page, which itself refers to other data objects. A client application, such as a browser, will request these additional data objects as it parses or otherwise processes the first data object.

Mobile client nodes 84 may use other communications protocols and data formats. For example, mobile client nodes 84, in some implementations, may include Wireless Application Protocol (WAP) functionality and a WAP browser. The use of other wireless or mobile device protocol suites are also possible, such as NTT DoCoMo's i-mode wireless network service protocol suites. In addition, the network environment may also include protocol translation gateways, proxies or other systems to allow mobile client nodes 84, for example, to access other network protocol environments. For example, a user may use a mobile client node 84 to capture an image and upload the image over the carrier network to a content site connected to the Internet.

D. Example Operation

In numerous applications (e.g., in a search platform supporting one or more search engines), network application hosting site 20 and/or one or more of its various components may maintain one or more priority queues or similar data structures (e.g, priority queues may maintain partially ordered lists of relevancy scores for search engine results). Accordingly, network application hosting site 20 and/or one or more of its various components may create and/or utilize one or more quickheaps, as discussed in greater details below.

A quickheap is based in part on a sorting algorithm known as an incremental quicksort (IQS) algorithm. Given a set of items A, IQS may search for a particular element of A.

In an embodiment of this disclosure, an “element” or “data element,” as such terms are used herein, may include any suitable item or items of data, including without limitation a search result, uniform resource locator, a web page title, a web page description, and/or other metadata associated with a web page.

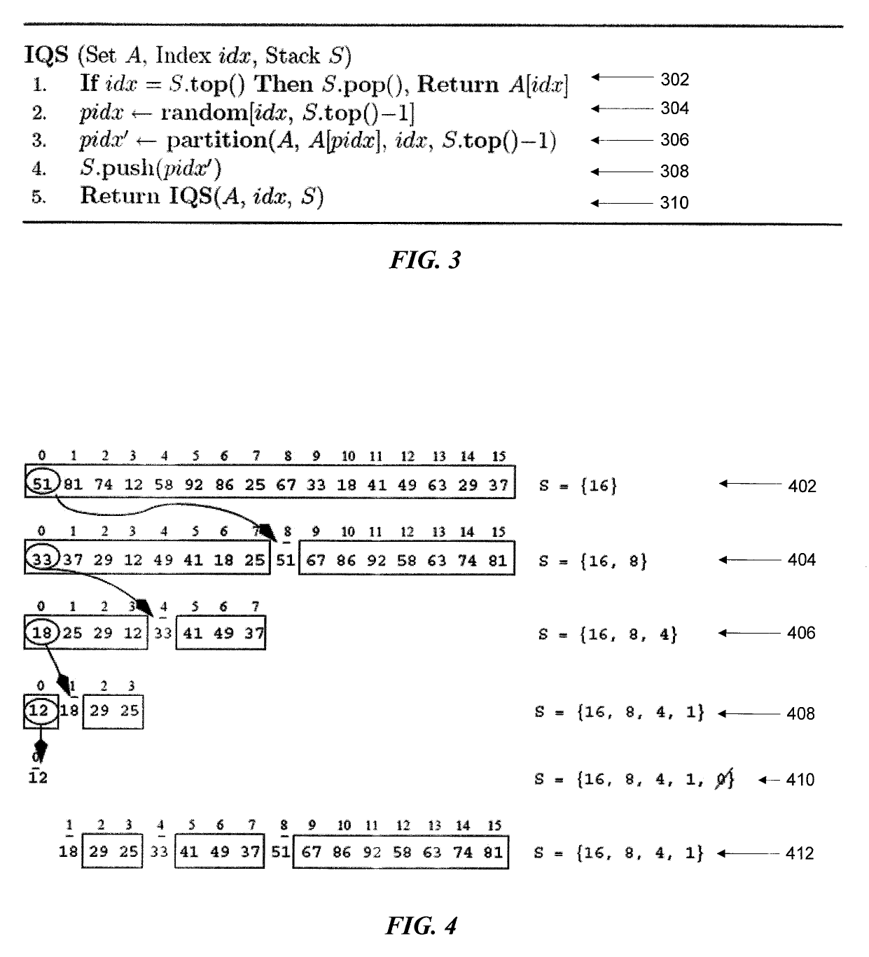

FIG. 3 illustrates an embodiment of the IQS algorithm set forth in pseudocode to which implementations of the invention may have application. As shown in FIG. 3, IQS may have a set A, an Index idx corresponding to the priority of the item sought (e.g., idx=0 would return highest priority, idx=1 would return the second highest priority, etc.), and a stack S passed as input variables. At step 302, IQS may determine whether the top element of S (S.top) is equal to the desired idx value. If S.top equals idx then the top value may be popped from S, and A[idx] (e.g., the value at position idx in A) may be returned. Otherwise, IQS may proceed to step 304.

At step 304, IQS may choose a random pivot index pidx between idx and S.top-1.

At step 306, IQS may partition A based on the value of pidx. The function partition (A, A[pidx], i,j) referenced at step 306 rearranges the subarray A[i,j] and returns the new position pidx′ of the original element in A[pidx], such that, in the rearranged array, all of the elements smaller than A [pidx′] appear before pidx′ and all elements larger than A[pidx′] appear after pidx′. Thus, pivot A[pidx′] is left at the correct position it would have in the hypothetical sorted array A[i,j].

At step 308, the value pidx′ is pushed onto stack S, such that S may maintain all pivot values present in A.

At step 310, IQS may recursively call itself, thus in effect continuing its search for the desired value on a subarray of A.

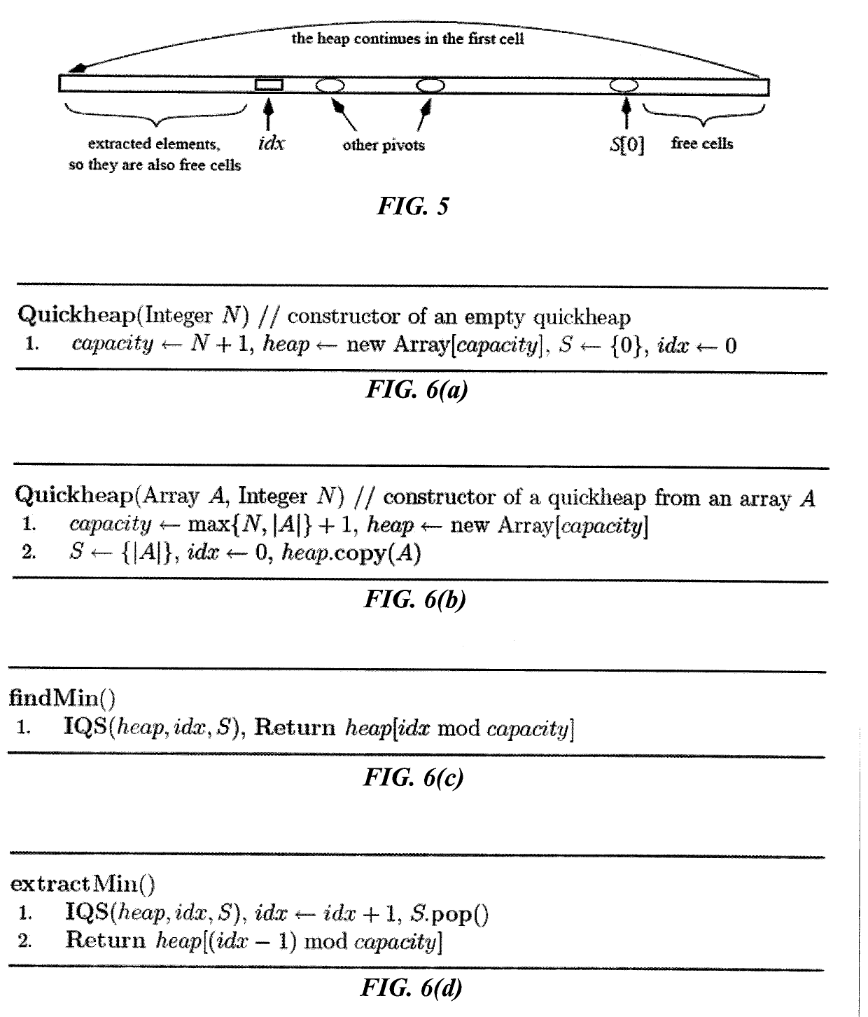

FIG. 4 illustrates an example execution of the IQS algorithm shown in FIG. 3, demonstrating how IQS may search for the smallest element (12) of an array A with size m=16. Because the smallest element would appear in position idx=0 in a sorted array, the value idx=0 is passed as an input to IQS. In addition, stack S is initialized with a single value equal to |A| (e.g., 16 in this example).

As shown in line 402 of FIG. 4, the first iteration of IQS may determine that idx (0) does not equal the top value of S (16), and may accordingly select the array value at position 0 (51) as a random pivot. Because the value 51 would appear at position 8 in a sorted array A, the partition operation may place 51 in position 8 (e.g., A[8]), and may rearrange A such that values lesser than 51 appear in A before 51, and values greater than 51 appear in A after 51, as shown in line 404. In addition, the pivot position (8) may be pushed into stack S.

As shown in line 404 of FIG. 4, the second iteration of IQS may determine that idx (0) does not equal the top value of S (8), and may accordingly select the array value at position 0 (33) as a random pivot. Because the value 33 would appear at position 4 in a sorted array A, the partition operation may place 33 in position 4 (e.g., A[4]), and may rearrange A such that values lesser than 33 appear in A before 33, and values greater than 33 appear in A after 33, as shown in line 406. In addition, the pivot position (4) may be pushed into stack S.

As shown in line 406 of FIG. 4, the third iteration of IQS may determine that idx (0) does not equal the top value of S (4), and may accordingly select the array value at position 0 (18) as a random pivot. Because the value 18 would appear at position 1 in a sorted array A, the partition operation may place 18 in position 1 (e.g., A[1]), and may rearrange A such that values lesser than 18 appear in A before 18, and values greater than 18 appear in A after 18, as shown in line 408. In addition, the pivot position (1) may be pushed into stack S.

As shown in line 408 of FIG. 4, the fourth iteration of IQS may determine that idx (0) does not equal the top value of S (1), and may accordingly select the array value at position 0 (12) as a random pivot. Because the value 12 would appear at position 0 in a sorted array A, the partition operation may keep 12 in position 0 (e.g., A[0]), and may rearrange A such that values greater than 12 appear in A after 12 (because 12 is in position 0, no values will be placed before 12). In addition, the pivot position (0) may be pushed into stack S.

As shown in line 410 of FIG. 4, the fifth iteration of IQS may determine that idx (0) is equal to the top value of S (0), and may accordingly pop the top value of stack S and return the value 12, the smallest value in array A. Line 412 depicts the resulting array A and stack S after IQS returns the desired value of A. The resulting array A is partially ordered, and the values in stack S represent positions of the pivots of array A, wherein such pivots are those values of A appearing in the position of A they would appear in a fully sorted array A. It is noted that the value of 16 within S, as shown in FIG. 4, may represent a fictitious pivot of ∞ at fictitious bit position 16. Such fictitious pivot may be required as an initial input into IQS, to allow proper execution of IQS. When the resulting array is read from right to left, the array starts with a pivot (fictitious pivot of ∞ at fictitious bit position 16), and to the left of such pivot are a collection of elements smaller than it. Next, another pivot is encountered (the value of 51 at position 8), and another collection of elements, and so on. The resulting data structure resembles a heap structure, as the elements are semi-ordered. Accordingly, the present disclosure exploits this property to provide the quickheap, a priority queue over an array processed with algorithm IQS.

In accordance with the present disclosure, a quickheap may be implemented using one or more sub-structures, including, without limitation, an array heap, a stack S, an integer idx, and an integer capacity. Array heap may be used to store individual elements of the quickheap. In the example depicted in line 412 of FIG. 4, heap may be expressed as {18, 29, . . . , 81, ∞}.

Stack S may be used to store the positions of the pivots partitioning heap. In the example depicted in line 412 of FIG. 4, S may be depicted as {16, 8, 4, 1}, wherein the bottom pivot index 16 indicates the fictitious pivot of ∞.

Integer idx may be used to indicate the first cell of a quickheap. In the example depicted in line 412 of FIG. 4, idx may equal 1. A separate variable to indicate the last cell of a quickheap may not be needed, as the last cell of the quickheap (the fictitious pivot ∞), may be stored in S[0].

Integer capacity may indicate the size of heap. Up to capacity −1 elements may be stored in the quickheap, as one cell is needed to the fictitious pivot ∞. In certain embodiments, heap may be implemented as a circular array, such that arbitrarily long sequences of insertions and deletions may be carried out as along as no more than capacity −1 elements are simultaneously maintained in the quickheap. In the case that heap is implemented as a circular array, one must take into account that an element whose position pos in the quickheap is actually located in the cell pos mod capacity of the circular array heap.

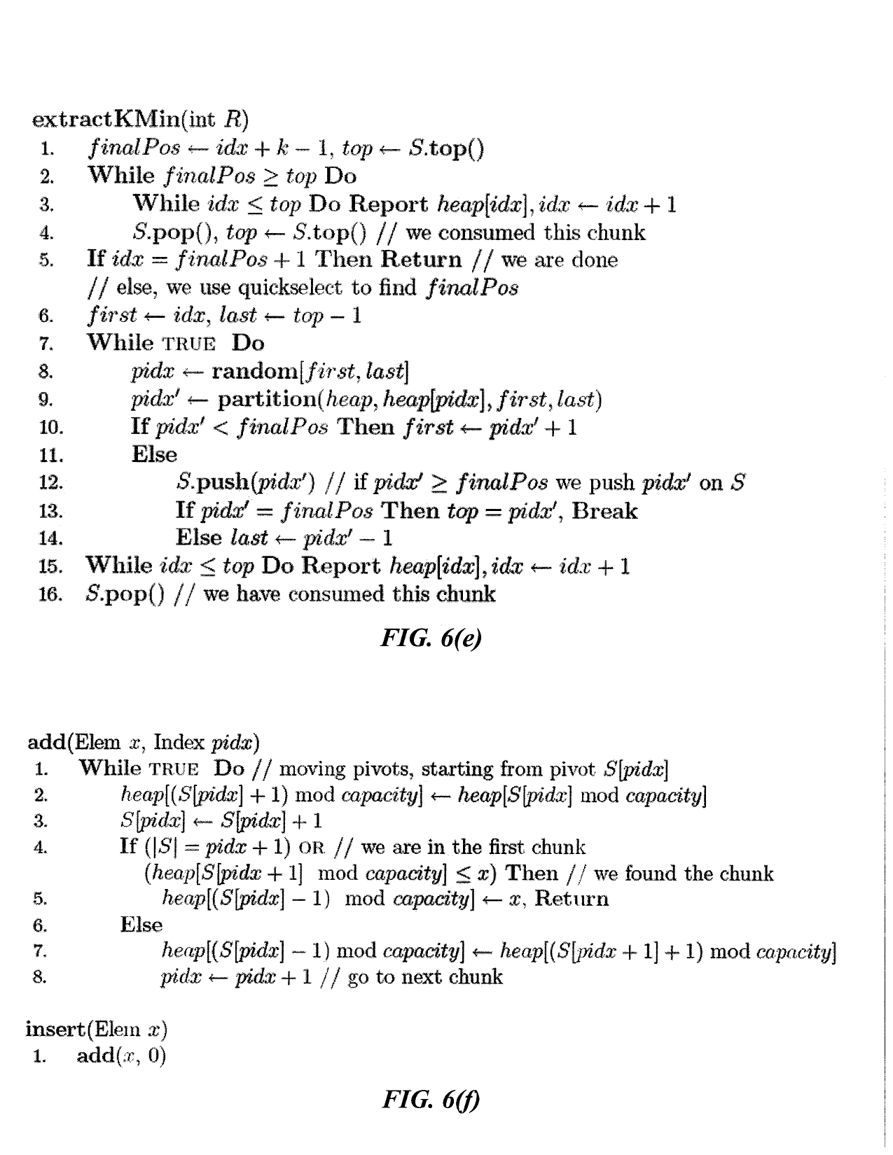

FIG. 5 illustrates the sub-structures of the quickheap data structure discussed above. In the example depicted in FIG. 5, the quickheap starts at cell idx, has three pivots, with its last cell marked by the fictitious pivot S[0]. Cells after S[0] may be free cells, such that elements may be added to the tail of the quickheap (e.g., the array cell heap[S[0] mod capacity]). Extractions of minima may be performed from the head of the quickheap (e.g., the array cell heap[idx mod capacity]). Thus, free cells may also exist before heap[idx] which correspond to extracted elements. The cells before heap[idx] may also be used when the quickheap “turns around” the circular array heap. Accordingly, the quickheap may “slide” from left to right over the circular array heap as quickheap operations progress.

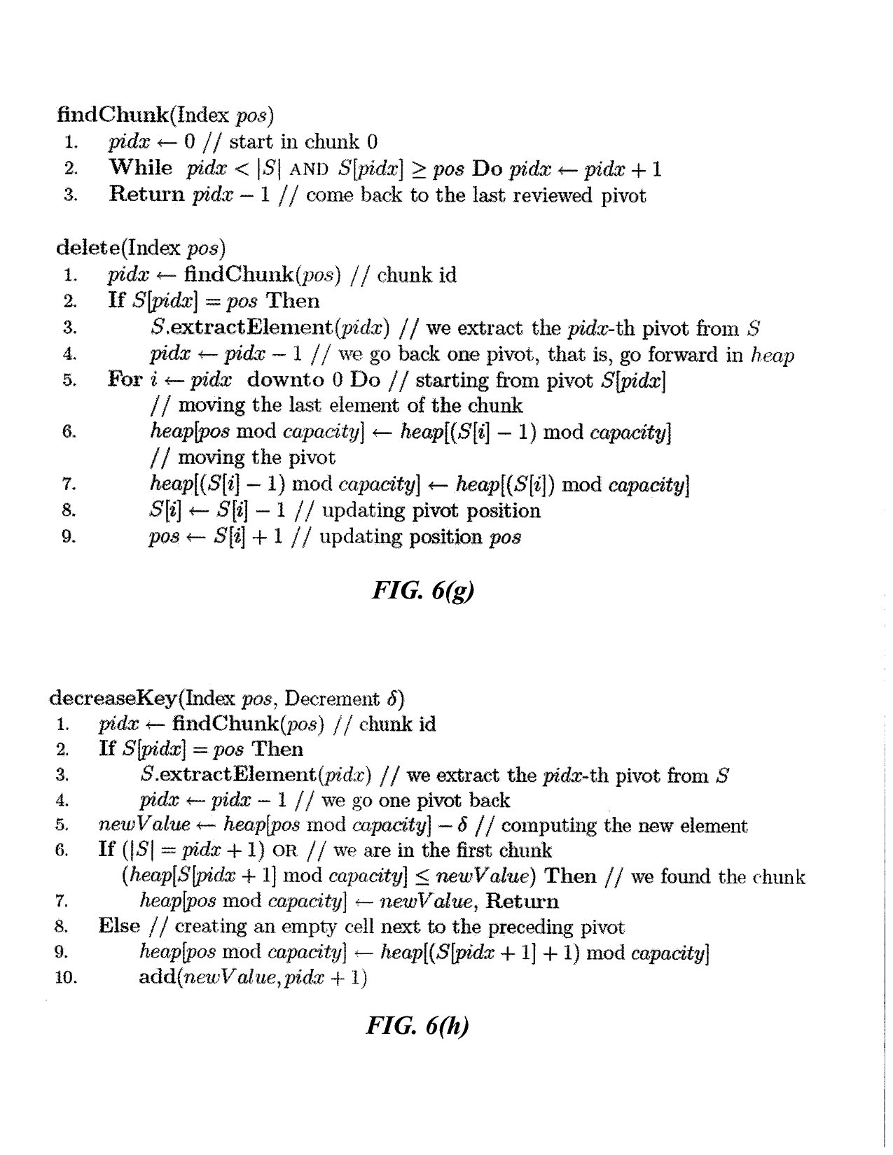

FIGS. 6A-6H illustrate example pseudo-code for implementing various quickheap operations. The operations depicted in FIGS. 6A-6H are each described in detail below. In the discussion below, the expression “mod capacity” has been omitted for purposes of clarity and exposition, although such expression appears in the pseudo-code depicted in FIGS. 6A-6H.

FIG. 6A depicts example pseudo-code for an operation Quickheap(Integer N) for creating an empty quickheap. Given an input N, Quickheap(Integer N), may create an array heap with a size capacity=N+1 with no elements. When creating an empty array using Quickheap(Integer N), S and idx may be initialized such that S={0} and idx=0. In certain embodiments, it may not be necessary to place a value representing ∞ in heap[S[0]], as the S[0]-th cell may not be accessed during any quickheap operation.

FIG. 6B depicts example pseudo-code for an operation Quickheap(Array A, Integer N) for “heapifying” an existing array A. Given an array A and integer N as inputs, Quickheap(Array A, Integer N) may copy array A to heap, and initialize both S=|A| and idx=0. The value of capacity may be initialized to the greater of N and |A|+1.

FIG. 6C depicts example pseudo-code for an operation findMin( ) for finding the minimum value in a quickheap. Because idx indicates the first cell used by the quickheap allocated over the array heap, and the pivots stored in S delimit chunks of semi-ordered elements, the minimum of the quickheap must be placed within the first chunk (e.g., within the subarray heap[idx, S.top( )−1]). Accordingly, to find the minimum, IQS (heap, idx, S), a variant of the IQS algorithm previous discussed, may be used to find the minimum from the first chunk, and then return the element heap[idx]. The variant of IQS called may take into account any circular nature of heap and/or may not perform the pop( ) operation of step 302 of FIG. 3.

FIG. 6D depicts example pseudo-code for an operation extractMin( ) for finding and extracting the minimum value in a quickheap. The operation extractMin( ) is similar to findMin( ) depicted in FIG. 6C, with the key difference that in extractMin( ), the minimum value is not only found, but also extracted (e.g., removed) from the quickheap. Accordingly, an IQS variant identical or similar to that called in findMin( ) may be used to put the minimum into position idx of heap. In addition, idx may be incremented and the top value of S may be popped in order to abstractly “remove” the minimum value from the quickheap. The value of the minimum may be returned by returning heap[idx−1].

FIG. 6E depicts example pseudo-code for an operation extractKMin(int k) that may, based on a received input k, find and extract the minimum k values in a quickheap. Because idx equals the first cell of the quickheap allocated in the array heap and pivots stored in S delimit chunks of semi-ordered elements, a multi-extraction of k minima may be performed using the algorithm set forth in FIG. 6E. The operation extractKMin(int k) may compute a position finalPos=idx+k−1, which is the k-th cell of the current extraction of k-elements. After finalPos is calculated, extractKMin(int k) may traverse S. All of the pivots in S placed before finalPos belong to the k-element set of minima sought, so all such pivots are reported (including extraction of such elements) as well as their respective chunks of elements (e.g., all pivots to the left of finalPos and the chunks to the left of such pivots). The value of idx may also be updated as minima are reported. If idx exceeds finalPos after the steps recited above, then all k desired minima have been reported. Otherwise, a quickselect procedure similar to IQS may be used to find the finalPos-th element in the chunk delimited by idx and S.top( )−1. During this quickselect procedure, all pivots in positions greater than or equal to finalPos are pushed into stack S. At the completion of the quickselect procedure, the pivot on top of S is finalPos. Accordingly, all elements from idx to finalPos are reported and the pivot on top of S at position finalPos is extracted.

FIG. 6F depicts example pseudo-code for operations add(Elem x, Index pidx) and insert (Elem x) for inserting a new element x into a quickheap. To insert a new element x into a quickheap, the operations must find the chunk where x may be inserted in accordance with the pivot positions existing in S, and then create an empty cell within the chunk in the array heap. In order to carry out the insertion of element x, the fictitious pivot representing the value ∞ may be moved one position to the right and its position may be updated in S. Moving the fictitious pivot in this manner creates a free cell in the last chunk of heap. Next, the value of x may be compared with the pivot at cell heap[S[1]]. If the pivot is smaller than or equal to x, x is placed in the free position left by the pivot at heap[S[0]]. Otherwise, the first element to the right of heap[S[1]] may be moved to the free position left by the pivot at heap[S[0]], and the pivot heap[S[1]] may be moved one position to the right, updating its position in S. This process may be repeated with the pivot at heap[S[2]] and so on until the position where x is to be placed is found, or the first chunk is reached. As shown in FIG. 6F, operation insert(Elem x) may use the operation add(Elem x, Index pidx). Operation add(Elem x, Index pidx) receives as inputs x, the value to be added, and pidx, which indicates the chunk at which the displacement process is to begin. For insertions, the pivot displacement process starts from the last chunk (as discussed above), thus operation insert(Elem x) calls add(Elem x, Index pidx) and initialized pidx=0. However, both operations are shown in FIG. 6F, as the operation add(Elem x, Index pidx) will be discussed again below with respect to other quickheap operations.

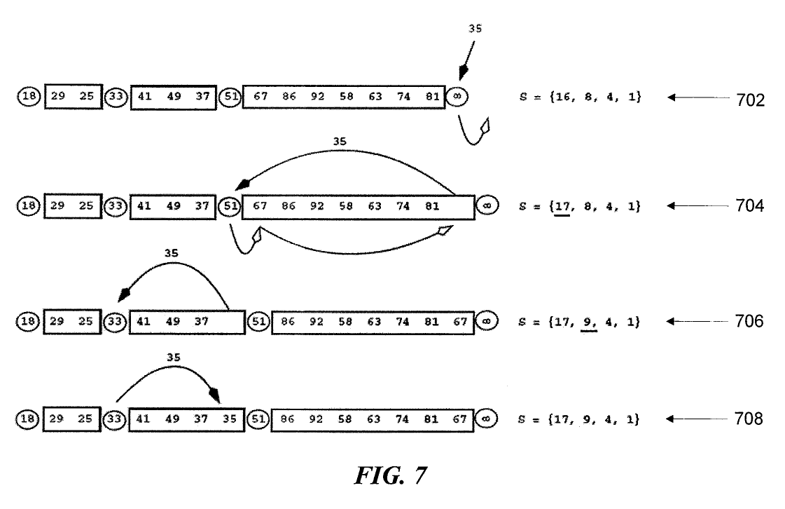

FIG. 7 depicts a diagram graphically illustrating the insertion of a new element (35) into a quickheap with the elements and pivots shown in line 412 of FIG. 4, in accordance with the operations depicted in FIG. 6F. At line 702, fictitious pivot ∞ is moved one position to the right. At line 704, the position of ∞ may be updated in S (from 16 to 17), and the new element (35) may be compared to with pivot heap[S[1]]=51. Because 35<51, the element 67, which is to the right of 51, is moved to the end of the last of the chunk and pivot 51 is moved one position to the right. At line 706, the position of 51 may be updated in S (from 8 to 9), and the new element (35) may be compared to the next pivot 33. Because 35>33, 35 is stored in the second to last chunk at the free position left by pivot 51 as shown at line 708.

FIG. 6G depicts example pseudo-code for operations delete(Index pos) and findChunk (Index pos) for deleting an arbitrary element at position pos in a quickheap. The delete(Index pos) operation may be though of as the dual of the insert operation discussed above.

It is noted that applications may not “know” the internal positions of elements in a quickheap, but only their identifiers. Hence, in order to implement the delete operation, the quickheap may need to be augmented with a dictionary which, given an element identifier, answers its respective position. Such dictionary would need to remain synchronized with respect to element positions. For purposes of this disclosure, any suitable implementation of a dictionary may be used. For example, if it is known beforehand how many elements will need to be managed in a quickheap, and all element identifiers are consecutive integers, it may be sufficient to add another array to implement the dictionary. Otherwise, the dictionary may be managed with a hash table, an AVL tree, it any other suitable data structure. In the discussion below, it is assumed that a dictionary is available that is operable to maintain the element positions in the quickheap updated.

Using the dictionary, the position pos of an element to be deleted may be obtained. As shown in FIG. 6G, the delete(Index pos) operation may need to determine the chunk within heap that contains the element. Because each chunk has a pivot at its right, each chunk may be referenced by its associated pivot. Therefore, operation findChunk(Index pos) may traverse stack S to find the smallest pivot that is larger than or equal to pos.

After findChunk(Index pos) determines a pivot position pidx at a position greater then the element at pos, the following process is repeated. The element heap[S[pidx]−1] may be moved to position heap[pos] (e.g., the element previous to the pidx-th pivot is placed in the position pos) creating a free cell position at S[pidx]−1. The pivot heap[S[pidx]] may be moved one place to the left, and its position may be updated in S. Next, pos may be updated to the old pivot position pos=S[pidx]+1, the and the next chunk to the right may be processed using the steps described above. The process may continue until the fictitious pivot is reached.

FIG. 6H depicts example pseudo-code for an operation decreaseKey(Index pos, Decrement δ) for decreasing the value of an element at position pos by an amount δ, and adjusting its position in the quickheap according to the pivots stored in S. As in the delete operation discussed above, a dictionary may be used to obtain the position of a particular element. As the value of the element is being decreased, the modified element either remains in its current place or is moved chunk-wise towards position idx. In this sense, decreaseKey(Index pos, Decrement δ) is similar in operation to insert(Elem x) in that both of them use the auxiliary method add (Elem x, Index pidx). To decrease the value of an element, decreaseKey(Index pos, Decrement δ) first determines the chunk pidx of the element to modify using findChunk(Index pos). If the element at position pos is a pivot, it is extracted from S, and then the previous pivot is referenced, such that there is always a pivot at a position greater than pos. Using methods similar to decreaseKey(Index pos, Decrement δ), a similar operation whereby the value of an element is increased and its position is changed may also be provided.

E. Example Computing System Architectures

While the foregoing systems and methods can be implemented by a wide variety of physical systems and in a wide variety of network environments, the client and server host systems described below provide example computing architectures for didactic, rather than limiting, purposes.

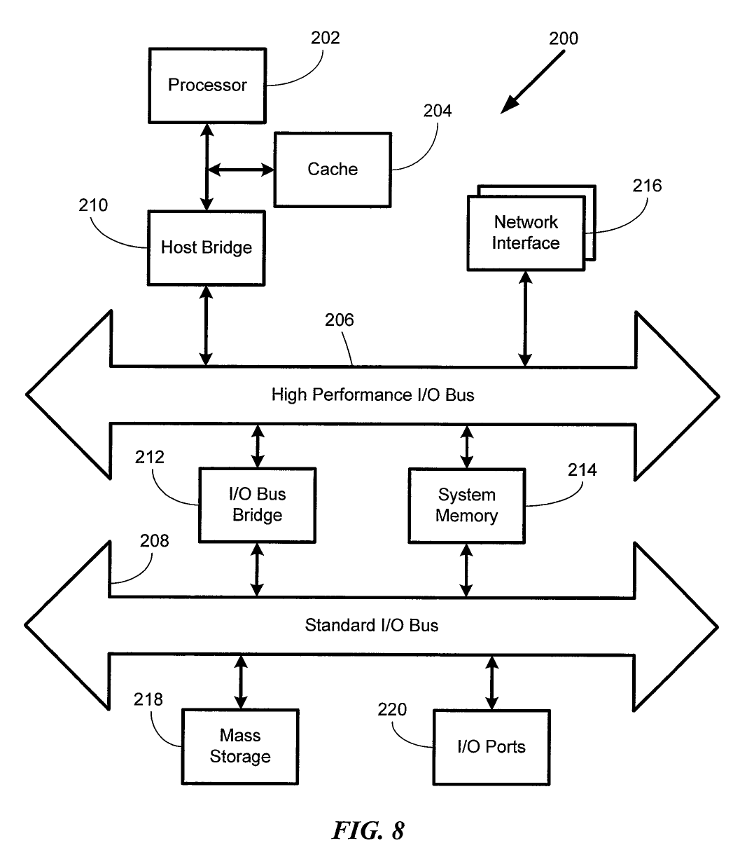

FIG. 8 illustrates an example computing system architecture, which may be used to implement a physical server. In one embodiment, hardware system 200 comprises a processor 202, a cache memory 204, and one or more software applications and drivers directed to the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218, and I/O ports 220 couple to bus 208. Hardware system 200 may optionally include a keyboard and pointing device, and a display device (not shown) coupled to bus 208. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the location server 22, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain embodiments of the present invention may not require nor include all of the above components. For example, the peripheral devices shown coupled to standard I/O bus 208 may couple to high performance I/O bus 206. In addition, in some embodiments only a single bus may exist, with the components of hardware system 200 being coupled to the single bus. Furthermore, hardware system 200 may include additional components, such as additional processors, storage devices, or memories.

As discussed below, in one implementation, the operations of one or more of the physical servers described herein are implemented as a series of software routines run by hardware system 200. These software routines comprise a plurality or series of instructions to be executed by a processor in a hardware system, such as processor 202. Initially, the series of instructions may be stored on a storage device, such as mass storage 218. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present invention, the operating system is the Windows® 95/98/NT/XP/Vista operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like. Of course, other implementations are possible. For example, the server functionalities described herein may be implemented by a plurality of server blades communicating over a backplane.

Furthermore, the above-described elements and operations can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing devices are integrated circuits and logic circuitry. Those skilled in the art are familiar with instructions, computers, and storage media.

What is claimed is:

1. A method for maintaining a priority queue, comprising:
storing an array on computer-readable media, the array including a plurality of cells, each cell including a data element and having a position within the array;
storing a data structure on the computer-readable media, the data structure including at least one variable indicating at least one pivot cell in the array, wherein each pivot cell includes a pivot data element such that the pivot data element is positioned in the cell that the pivot data element would be positioned in if all data elements of the array were fully sorted;
storing a first integer on the computer-readable media, the first integer indicating a first cell position of the array; and
storing a second integer on the computer-readable media, the second integer indicating a capacity of the array.

2. A method according to claim 1, further comprising positioning each pivot cell such that its associated pivot data element is of lesser priority than cells positioned to a first side of the pivot cell and is of a greater priority than cells positioned to a second side of the pivot cell.

3. A method according to claim 1, further including implementing the data structure as a stack.

4. A method according to claim 1, further including implementing the array as a circular array.

5. A method according to claim 1, further comprising finding the highest priority data element of the array by:
determining the pivot data element of highest priority;
determining if the array includes other data elements of higher priority than the highest-priority pivot data element;
if the array does not include data elements of a higher priority than the highest-priority pivot data element, returning the highest-priority pivot data element; and
if the array includes data elements of a higher priority than the highest-priority pivot data element, sorting the one or more of the other data elements and returning the other data element with the highest priority.

6. A method according to claim 5, further comprising incrementing the first integer.

7. A method according to claim 1, further comprising adding a new data element to the array by inserting the data element into a cell positioned between a first pivot data element of higher priority than the new data element and a second pivot data element of lower priority than the new data element.

8. An apparatus, comprising:
one or more processors;
a memory; and
computer-executable instructions carried on computer readable media, the instructions readable by the one or more processors, the instructions, when read and executed, for causing the one or more processors to:
store an array on the computer-readable media, the array including a plurality of cells, each cell including a data element and having a position within the array;
store a data structure on the computer-readable media, the data structure including at least one variable indicating at least one pivot cell in the array, wherein each pivot cell includes a pivot data element such that the pivot data element is positioned in the cell that the pivot data element would be positioned in if all data elements of the array were fully sorted;
store a first integer on the computer-readable media, the first integer indicating a first cell position of the array; and
store a second integer on the computer-readable media, the second integer indicating a capacity of the array.

9. An apparatus according to claim 8, further including computer-executable instructions for causing the one or more processors to position each pivot cell such that its associated pivot data element is of lesser priority than cells positioned to a first side of the pivot cell and is of a greater priority than cells positioned to a second side of the pivot cell.

10. An apparatus according to claim 8, further including computer-executable instructions for causing the one or more processors to implement the data structure as a stack.

11. An apparatus according to claim 8, further including computer-executable instructions for causing the one or more processors to implement the array as a circular array.

12. An apparatus according to claim 8, further including computer-executable instructions for causing the one or more processors to find the highest priority data element of the array by:
determining the pivot data element of highest priority;
determining if the array includes other data elements of higher priority than the highest-priority pivot data element;
if the array does not include data elements of a higher priority than the highest-priority pivot data element, returning the highest-priority pivot data element; and
if the array includes data elements of a higher priority than the highest-priority pivot data element, sorting the one or more of the other data elements and returning the other data element with the highest priority.

13. An apparatus according to claim 12, further including computer-executable instructions for causing the one or more processors to increment the first integer.

14. An apparatus according to claim 8, further including computer-executable instructions for causing the one or more processors to add a new data element to the array by inserting the data element into a cell positioned between a first pivot data element of higher priority than the new data element and a second pivot data element of lower priority than the new data element.

15. An article of manufacture comprising:
a computer readable medium; and
computer-executable instructions carried on the computer readable medium, the instructions readable by a processor, the instructions, when read and executed, for causing the processor to:
store an array on the computer-readable media, the array including a plurality of cells, each cell including a data element and having a position within the array;
store a data structure on the computer-readable media, the data structure including at least one variable indicating at least one pivot cell in the array, wherein each pivot cell includes a pivot data element such that the pivot data element is positioned in the cell that the pivot data element would be positioned in if all data elements of the array were fully sorted;
store a first integer on the computer-readable media, the first integer indicating a first cell position of the array; and
store a second integer on the computer-readable media, the second integer indicating a capacity of the array.

16. An article of manufacture according to claim 15, further including computer-executable instructions for causing the one or more processors to position each pivot cell such that its associated pivot data element is of lesser priority than cells positioned to a first side of the pivot cell and is of a greater priority than cells positioned to a second side of the pivot cell.

17. An article of manufacture according to claim 15, further including computer-executable instructions for causing the one or more processors to implement the data structure as a stack.

18. An article of manufacture according to claim 15, further including computer-executable instructions for causing the one or more processors to implement the array as a circular array.

19. An article of manufacture according to claim 15, further including computer-executable instructions for causing the one or more processors to find the highest priority data element of the array by:
determining the pivot data element of highest priority;
determining if the array includes other data elements of higher priority than the highest-priority pivot data element;
if the array does not include data elements of a higher priority than the highest-priority pivot data element, returning the highest-priority pivot data element; and
if the array includes data elements of a higher priority than the highest-priority pivot data element, sorting the one or more of the other data elements and returning the other data element with the highest priority.

20. An article of manufacture according to claim 15, further including computer-executable instructions for causing the one or more processors to add a new data element to the array by inserting the data element into a cell positioned between a first pivot data element of higher priority than the new data element and a second pivot data element of lower priority than the new data element.
